(19) United States
(12) Patent Application Publication
(10) Pub. No.: US 2013/0102334 A1
(43) Pub. Date: Apr. 25, 2013

(54) EGRESS BASED MAP REGION CLASSIFICATION

(71) Applicants: Behrooz Khorashadi, Mountain View, CA (US); Vinay Sridhara, Santa Clara, CA (US); Saumitra M. Das, San Jose, CA (US); Christopher A. Vick, Santa Clara, CA (US)

(72) Inventors: Behrooz Khorashadi, Mountain View, CA (US); Vinay Sridhara, Santa Clara, CA (US); Saumitra M. Das, San Jose, CA (US); Christopher A. Vick, Santa Clara, CA (US)

(73) Assignee: QUALCOMM Incorporated, San Diego, CA (US)

(21) Appl. No.: 13/572,561

(22) Filed: Aug. 10, 2012

Related U.S. Application Data
(60) Provisional application No. 61/550,316, filed on Oct. 21, 2011.

(51) Int. Cl. G06K 9/46; H04W 4/02

(52) U.S. Cl. 455/457; 382/195

(57) ABSTRACT

Disclosed are systems, methods and techniques for classifying portions of an area depicted in a digitally encoded map. For example, features in a digitally encoded map may be extracted to identify a component area at least partially bounded by a perimeter formed by structures. One or more egress segments in the perimeter may be identified and characterized. The component area may then be classified based, at least in part, on a proportionality of a length of the egress segment to a size of at least one dimension of the component area.

### CLAIM OF PRIORITY UNDER 35 U.S.C. §119

This application claims the benefit of U.S. Provisional Application No. 61/550,316, filed on Oct. 21, 2011, which is assigned to the assignee hereof, and expressly incorporated herein by reference.

### BACKGROUND

1. Field:

The subject matter herein relates to techniques for characterizing an environment based, at least in part, on map features.

2.Information:

GPS and other like satellite positioning systems have enabled navigation services for mobile handsets in outdoor environments. Since satellite signals may not be reliably received and/or acquired in an indoor environment, different techniques may be employed to enable navigation services. For example, mobile devices can typically obtain a position fix by measuring ranges to three or more terrestrial wireless access points which are positioned at known locations. Such ranges may be measured, for example, by obtaining a MAC ID address from signals received from such access points and measuring one or more characteristics of signals received from such access points such as, for example, signal strength, round trip delay, just to name a few examples.

In some implementations, an indoor navigation system may provide a digital electronic map to a mobile device upon entry to a particular indoor area. Such a map may show indoor features such as doors, hallways, entry ways, walls, etc., points of interest such as bathrooms, pay phones, room names, stores, etc.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a system diagram illustrating certain features of a system containing a mobile device, in accordance with an implementation.

FIG. 2 is a map of an indoor area showing features indicative of a classification of portions within the indoor area in accordance with an implementation.

FIG. 3 shows features of map forming a perimeter around an area according to an embodiment.

FIG. 4 shows a feature of a map being extended in accordance with an embodiment.

FIG. 5 is a depiction of an egress segment, in accordance with an embodiment.

FIGS. 6 and 7 are depictions of a length of an egress segment and a size of at least one dimension of a room in accordance with an embodiment.

FIG. 8 is a flow diagram of a process for classifying an area depicted in an indoor map according to an embodiment.

FIG. 9 is a schematic block diagram illustrating an exemplary mobile device, in accordance with an implementation.

FIG. 10 is a schematic block diagram of an example computing platform.

### SUMMARY

Particular implementations are directed to a method of classifying portions of an area represented in a map comprising: executing instructions by a computing device to: characterize a dimensionality of a bounded component area of a larger area represented in a digitally encoded map stored in a memory based, at least in part, on features extracted from the digitally encoded map; and generate one or more signals indicating a classification of the component area based, at least in part, on the characterized dimensionality.

Other particular implementations are directed to an apparatus for classifying portions of an area represented in a map comprising: a memory device; and a processor to: characterize a dimensionality of a bounded component area of a larger area represented in a digitally encoded map stored in the memory device based, at least in part, on features extracted from the digitally encoded map; and generate one or more signals indicating a classification of the component area based, at least in part, on the characterized dimensionality.

In other implementations, an article may comprise: a non-transitory storage medium comprising machine-readable instructions stored thereon which are executable by a special purpose computing apparatus to: extract features from a digitally encoded map stored in a memory device; characterize a dimensionality of a bounded component area of a larger area represented by said digitally encoded map stored in said memory device based, at least in part, on said extracted features and generate one or more signals indicating a classification of the component area based, at least in part, the characterized dimensionality.

In yet another implementation, an apparatus for classifying portions of an area represented in a digitally encoded map comprises: means for characterizing a dimensionality of a bounded component area of a larger area represented in the digitally encoded map stored in a memory based, at least in part, on features extracted from said digitally encoded map; and means for classifying the component area based, at least in part, on the characterized dimensionality.

In yet another implementation, a method of displaying a location of a mobile device comprises: receiving one or more signals from one or more sensors responsive to movement of the mobile device; inferring that a user co-located with the mobile device is performing a particular physical activity based, at least in part, on the received one or more signals; determining a classification of at least one bounded area in an electronic map; and displaying the location of the mobile device on the electronic map as being inside of or outside of the at least one bounded area based, at least in part, on the classification of the at least one bounded area and in response to inferring that said user co-located with the mobile device is performing the particular physical activity.

In yet another implementation, an apparatus comprises: one or more sensors to generate one or more signals responsive to movement of a mobile device; a display device; and one or more processors to: infer that a user co-located with the mobile device is performing a particular physical activity based, at least in part, on the one or more signals generated by the one or more sensors; determine a classification of at least one bounded area in an electronic map; and initiate display of an image on the display device indicating a location of the mobile device on the electronic map as being inside of or outside of the at least one bounded area based, at least in part, on the classification of the at least one bounded area and in response to inferring that said user co-located with the mobile device is performing the particular physical activity.

In yet another implementation an article comprises: a non-transitory storage medium comprising machine-readable instructions stored thereon which are executable by a special purpose computing apparatus to: a display device; and one or more processors to: infer that a user co-located with a mobile device is performing a particular physical activity based, at least in part, on one or more signals generated by one or more sensors responsive to movement of the user; determine a classification of at least one bounded area in an electronic map; and initiate display of an image on the display device indicating a location of the mobile device on the electronic map as being inside of or outside of the at least one bounded area based, at least in part, on the classification of the at least one bounded area and in response to inferring that said user co-located with the mobile device is performing the particular physical activity.

In yet another implementation, an apparatus comprises: means for receiving one or more signals from one or more sensors responsive to movement of the mobile device; means for inferring that a user co-located with the mobile device is performing a particular physical activity based, at least in part, on the received one or more signals; means for determining a classification of at least one bounded area in an electronic map; and means for displaying a location of the mobile device on the electronic map as being inside of or outside of the at least one bounded area based, at least in part, on the classification of the at least one bounded area and in response to inferring that said user co-located with the mobile device is performing the particular physical activity.

### DETAILED DESCRIPTION

In one particular implementation, a digital map of an indoor area provided as assistance data to a mobile device may be enhanced by including a routing or routeability graph setting forth possible or feasible paths for transitioning between locations in an indoor area. These possible or feasible paths may be defined, at least in part, by particular physical features constraining or allowing movement over the area in question including, for example, walls, doorways, corridors, just to name a few examples. In one implementation, measurements obtained at a mobile device may be applied to a routing or routeabilty graph to, for example, estimate a location and/or motion state of the mobile device (e.g., compute an estimated location, velocity or trajectory of the mobile device).

In a particular implementation, a routing or routeability graph may be formed by projecting a grid of points over an area covered by a map of an indoor area such as a floor of an office building, shopping mall, school building, etc. Neighboring grid points may then be selectively connected by edges subject to features in the map to indicate possible direct transitions between locations of the neighboring points without obstruction (e.g., walls). Here, the connected grid points form “nodes” in a routeability graph for use in modeling movement of a mobile device in the indoor area.

In particular implementations, a location of a mobile device may be modeled as being placed at points along edges connecting neighboring nodes in the routeability graph described above. Likewise, transitions from an initial position to a subsequent position may be modeled to occur along edges of the routeability graph. In addition, a likelihood model may further characterize possible transitions of a mobile device from an initial position to a subsequent position over a time period. In a particular example, a particle filtering model may establish a likelihood that a mobile device have a particular subsequent location, velocity and heading that is conditioned on an initial location, velocity and heading.

In one implementation, a routing or routeability graph may be incorporated as constraints in a motion model (e.g., Kalman filter or particle filter) for estimating a location and/or motion state of the mobile device. Such a motion model may employ a “probability heatmap” to express likelihoods of transitioning to any one of possible future states given a certain initial state. For example, a probability heatmap may express a likelihood of a mobile device transitioning to any one of multiple possible or feasible locations at a future time given a certain current location of the mobile device.

In a particular implementation of applying a probability heatmap in a particle filtering application, the probability heatmap may express a likelihood that a path taken in the indoor area passes through particular junctions connecting edges in a routeability graph. In one implementation, a probability heatmap may express likelihoods of transitioning through an area in an indoor map defined, at least in part, by a boundary or perimeter formed by obstructions in the indoor map. It may be observed that a likelihood of transitioning between particular junctions in an area may be affected, at least in part, by a class or type of the area. For example, a likelihood of transitioning between particular junctions in an area may be different in a room, entry to a building, hallway, etc. As discussed below in connection with particular example implementations, a portion of an area defined in an indoor map may be classified in a manner indicative of likely movement in or through portion of the area based, at least in part, on features expressed in the indoor map. These classifications of portions in an indoor area may then be used to define or refine a probability heatmap for use in application of a motion model to estimate a current location.

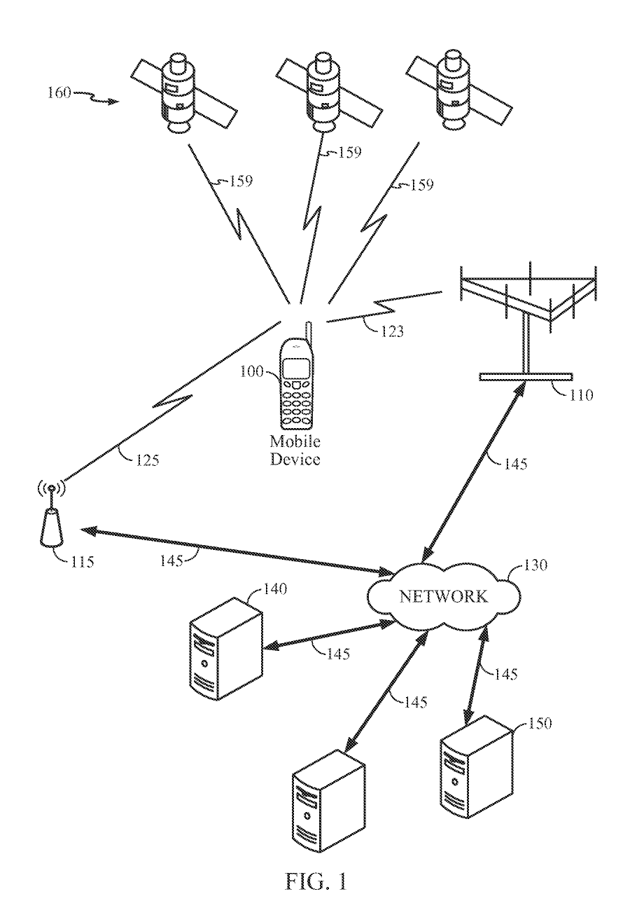

In certain implementations, as shown in FIG. 1, a mobile device 100 may receive or acquire Satellite Positioning System (SPS) signals 159 from SPS satellites 160. In some embodiments, SPS satellites 160 may be from one global navigation satellite system (GNSS), such as the GPS or Galileo satellite systems. In other embodiments, the SPS Satellites may be from multiple GNSS such as, but not limited to, GPS, Galileo, Glonass, or Beidou (Compass) satellite systems. In other embodiments, SPS satellites may be from any one several regional navigation satellite systems (RNSS') such as, for example, WAAS, EGNOS, QZSS, just to name a few examples.

In addition, the mobile device 100 may transmit radio signals to, and receive radio signals from, a wireless communication network. In one example, mobile device may communicate with a cellular communication network by transmitting wireless signals to, or receive wireless signals from, a base station transceiver 110 over a wireless communication link 123. Similarly, mobile device 100 may transmit wireless signals to, or receive wireless signals from a local transceiver 115 over a wireless communication link 125.

In a particular implementation, local transceiver 115 may be configured to communicate with mobile device 100 at a shorter range over wireless communication link 125 than at a range enabled by base station transceiver 110 over wireless communication link 123. For example, local transceiver 115 may be positioned in an indoor environment. Local transceiver 115 may provide access to a wireless local area network (WLAN, e.g., IEEE Std. 802.11 network) or wireless personal area network (WPAN, e.g., Bluetooth network). In another example implementation, local transceiver 115 may comprise a femto cell transceiver capable of facilitating communication on wireless communication link 125 according to a cellular communication protocol. Of course it should be understood that these are merely examples of networks that may communicate with a mobile device over a wireless link, and claimed subject matter is not limited in this respect.

In a particular implementation, base station transceiver 110 and local transceiver 115 may communicate with servers 140, 150 and 155 over a network 130 through links 145. Here, network 130 may comprise any combination of wired or wireless links. In a particular implementation, network 130 may comprise Internet Protocol (IP) infrastructure capable of transmitting pockets between mobile device 100 and servers 140, 150 or 155 through local transceiver 115 or base station transceiver 110. In another implementation, network 130 may comprise cellular communication network infrastructure such as, for example, a base station controller or master switching center to facilitate mobile cellular communication with mobile device 100.

In particular implementations, and as discussed below, mobile device 100 may have circuitry and processing resources capable of computing a position fix or estimated location of mobile device 100. For example, mobile device 100 may compute a position fix based, at least in part, on pseudorange measurements to four or more SPS satellites 160. Here, mobile device 100 may compute such pseudorange measurements based, at least in part, on of pseudonoise code phase detections in signals 159 acquired from four or more SPS satellites 160. In particular implementations, mobile device 100 may receive from server 140, 150 or 155 positioning assistance data to aid in the acquisition of signals 159 transmitted by SPS satellites 160 including, for example, almanac, ephemeris data, Doppler search windows, just to name a few examples.

In other implementations, mobile device 100 may obtain a position fix by processing signals received from terrestrial transmitters fixed at known locations (e.g., such as base station transceiver 110) using any one of several techniques such as, for example, advanced forward trilateration (AFLT) and/or observed time difference of arrival (OTDOA). In these particular techniques, a range from mobile device 100 may be measured to three or more of such terrestrial transmitters fixed at known locations based, at least in part, on pilot signals transmitted by the transmitters fixed at known locations and received at mobile device 100. Here, servers 140, 150 or 155 may be capable of providing positioning assistance data to mobile device 100 including, for example, locations and identities of terrestrial transmitters to facilitate positioning techniques such as AFLT and OTDOA. For example, servers 140, 150 or 155 may include a base station almanac (BSA) which indicates locations and identities of cellular base stations in a particular region or regions

In particular environments such as indoor environments or urban canyons, mobile device 100 may not be capable of acquiring signals 159 from a sufficient number of SPS satellites 160 or perform AFLT or OTDOA to compute a position fix. Alternatively, mobile device 100 may be capable of computing a position fix based, at least in part, on signals acquired from local transmitters (e.g., WLAN access points positioned at known locations). For example, mobile devices can typically obtain a position fix by measuring ranges to three or more indoor terrestrial wireless access points which are positioned at known locations. Such ranges may be measured, for example, by obtaining a MAC ID address from signals received from such access points and obtaining range measurements to the access points by measuring one or more characteristics of signals received from such access points such as, for example, received signal strength (RSSI) or round trip time (RTT). In alternative implementations, mobile device 100 may obtain an indoor position fix by applying characteristics of acquired signals to a radio “heatmap” indicating expected RSSI and/or RTT signatures at particular locations in an indoor area.

In particular implementations, mobile device 100 may receive positioning assistance data for indoor positioning operations from servers 140, 150 or 155. For example, such positioning assistance data may include locations and identities of transmitters positioned at known locations to enable measuring ranges to these transmitters based, at least in part, on a measured RSSI and/or RTT, for example. Other positioning assistance data to aid a mobile device with indoor positioning operations may include radio heatmaps, locations and identities of transmitters, routeability graphs, just to name a few examples. Other assistance data received by the mobile device may include, for example, local maps of indoor areas for display or to aid in navigation. Such a map may be provided to mobile device 100 as mobile device 100 enters a particular indoor area. Such a map may show indoor features such as doors, hallways, entry ways, walls, etc., points of interest such as bathrooms, pay phones, room names, stores, etc. By obtaining and displaying such a map, a mobile device may overlay a current location of the mobile device (and user) over the displayed map to provide the user with additional context.

In one implementation, a routeability graph and/or digital map may assist mobile device 100 in defining feasible areas for navigation within an indoor area and subject to physical obstructions (e.g., walls) and passage ways (e.g., doorways in walls). Here, by defining feasible areas for navigation, mobile device 100 may apply constraints to aid in the application of filtering measurements for estimating locations and/or motion trajectories according to a motion model (e.g., according to a particle filter and/or Kalman filter). In addition to measurements obtained from the acquisition of signals from local transmitters, according to a particular embodiment, mobile device 100 may further apply a motion model to measurements or inferences obtained from inertial sensors (e.g., accelerometers, gyroscopes, magnetometers, etc.) and/or environment sensors (e.g., temperature sensors, microphones, barometric pressure sensors, ambient light sensors, camera imager, etc.) in estimating a location or motion state of mobile device 100.

According to an embodiment, mobile device 100 may access indoor navigation assistance data through servers 140, 150 or 155 by, for example, requesting the indoor assistance data through selection of a universal resource locator (URL). In particular implementations, servers 140, 150 or 155 may be capable of providing indoor navigation assistance data to cover many different indoor areas including, for example, floors of buildings, wings of hospitals, terminals at an airport, portions of a university campus, areas of a large shopping mall, just to name a few examples. Also, memory resources at mobile device 100 and data transmission resources may make receipt of indoor navigation assistance data for all areas served by servers 140, 150 or 155 impractical or infeasible, a request for indoor navigation assistance data from mobile device 100 may indicate a rough or course estimate of a location of mobile device 100. Mobile device 100 may then be provided indoor navigation assistance data covering areas including and/or proximate to the rough or course estimate of the location of mobile device 100.

In one particular implementation, a request for indoor navigation assistance data from mobile device 100 may specify a location context identifier (LCI). Such an LCI may be associated with a locally defined area such as, for example, a particular floor of a building or other indoor area which is not mapped according to a global coordinate system. In one example server architecture, upon entry of an area, mobile device 100 may request a first server, such as server 140, to provide one or more LCIs covering the area or adjacent areas. Here, the request from the mobile device 100 may include a rough location of mobile device 100 such that the requested server may associate the rough location with areas covered by known LCIs, and then transmit those LCIs to mobile device 100. Mobile device 100 may then use the received LCIs in subsequent messages with a different server, such as server 150, for obtaining navigation assistance relevant to an area identifiable by one or more of the LCIs as discussed above (e.g., digital maps, locations and identifies of beacon transmitters, radio heatmaps or routeability graphs).

In particular implementations as described herein, a mobile device may extract features from an electronic or digitally encoded map and classify bounded areas depicted in the map. In a particular application, classifications of the bounded areas in the map may then be used by the mobile device to derive a probability heatmap for use by the mobile device in navigation applications to, for example, estimate a position or motion state of the mobile device. In other particular applications, a probability heatmap may be derived from features extracted from an electronic or digitally encoded map by the same or similar operations performed at a server device. Such a probability heatmap derived at a server device may then be transmitted to a mobile device over a communication network as positioning assistance data for use by the mobile device.

FIG. 2 is a map of an indoor area indicating placement of physical obstructions that may impede movement (e.g., walls, etc.). To enable movement of a mobile device between adjacent areas separated by a wall (e.g., adjacent rooms or a room and a corridor), doorways may be formed the wall. As shown in FIG. 2, a doorway may be depicted in a map as a discontinuity or break in a wall in which the doorway is formed. In another implementation, movement may be permitted between adjacent areas which are separated by other physical features through such a break or discontinuity. Such a discontinuity or break in a wall (or at least defining an opening through which movement may occur between adjacent areas) may be referred to herein as an “egress segment.” In a particular implementation, an egress segment may have a measurable size or width (e.g., a width or size of an opening in a wall forming a doorway).

In another implementation, a smaller component area within an area depicted in an indoor map may be defined, at least in part, by walls forming a perimeter around the smaller component area. For example, smaller component areas 202 and 204 in FIG. 2 may be defined, at least in part, by a perimeter formed by walls at least partially bounding component areas 202 and 204. In this particular illustration, one can observe that smaller component areas 202 and 204 serve different functions in an indoor space. For example, smaller component area 202 may serve as a corridor or hallway connecting rooms to facilitate a person to move freely along its length to move between rooms. In contrast, smaller component area 204 is less elongated and may serve as a room which may be entered or departed through doorways.

Particular implementations recognize that given a person's particular location in a particular smaller component area of a larger indoor area, the person may be predisposed to certain movement within the particular smaller component area based, at least in part, on a particular purpose or function for the smaller component area. As pointed out above, a smaller component area within a larger area may be classified, at least in part, by features indicative of a particular purpose or function inferred for the area. Here, by using map features to classify smaller component areas of a larger indoor area, transition likelihoods of a probability heatmap may be updated or constructed.

According to an embodiment, a smaller component area in a larger indoor area may be classified based, at least in part, on a proportionality of an egress segment in a perimeter at least partially bounding the smaller component area with respect to at least one dimension defining the at least partially bounded smaller component area. For example, as discussed below, a length of an egress segment (e.g., width of a doorway in a perimeter at least partially bounding the smaller component area) may be compared with a width of the smaller component area to determine whether the area should be classified as a room or a hallway. Here, proportionality of such an egress segment relative to a width of the smaller component area may be indicative or predictive of a flow of pedestrian traffic within the smaller component area, for example. For example, an egress segment length that is small relative to a width of the smaller component area may be indicative of a room (e.g., having a low flow of pedestrian traffic in and out of the egress segment). Conversely, an egress segment that is almost as long as a width of the area (e.g. width of the area measured as a length of a wall structure in which the egress segment is formed) may be indicative of a hallway or corridor (e.g., having a higher flow of pedestrian traffic along the length of the hallway or corridor). In other implementations, a bounded area may be classified as a hallway or corridor based, at least in part, on a number of egress segments formed in a structure forming a perimeter of the bounded area.

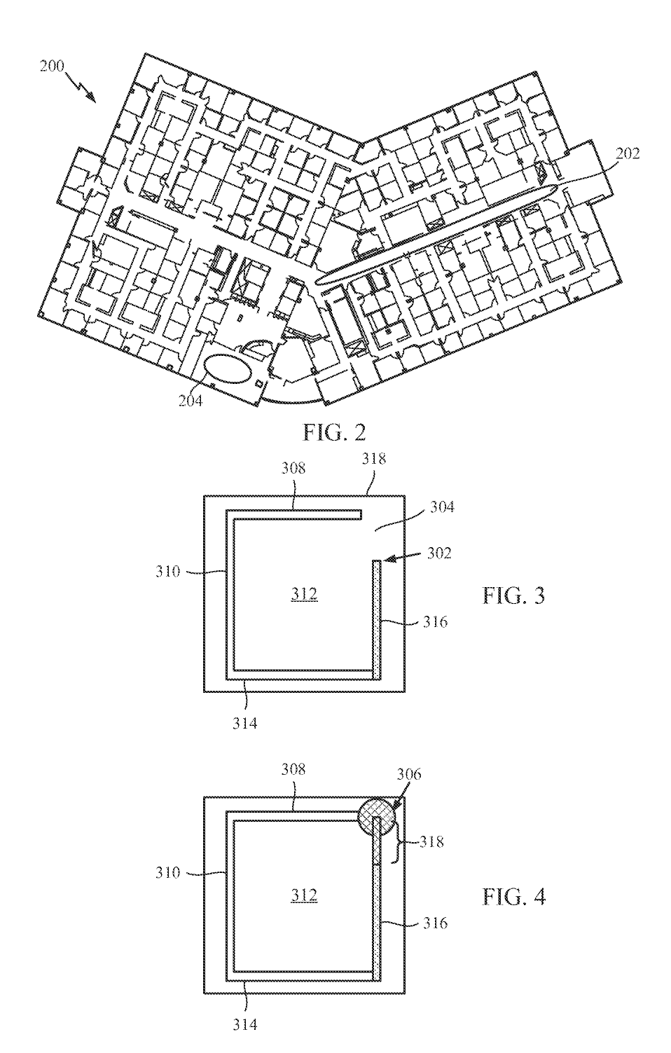

FIGS. 3 and 4 illustrate one example technique for identifying and measuring an egress segment in a perimeter at least partially bounding a portion of an indoor area according to an embodiment. In a particular implementation, FIGS. 3 and 4 may be representative of features of a portion of a digital map covering an area. A component area 312 is bounded by structures 308, 310, 314 and 316 forming a perimeter. Structures 308, 310, 314 and 316 may comprise walls or other physical barriers impeding movement between adjacent portions of the indoor area. In a particular implementation, the perimeter formed by structures 308, 310, 314 and 316 may bound a smaller component area of a larger area depicted in a digital map in any one of several formats such as, for example, a CAD format, JPEG format, vector formats, raster formats or bitmap. Here, features in the digital map, such as structures 308, 310, 314 and 316, may be extracted and characterized using any one of several feature recognition techniques for digital images such as a digital map. As discussed below, structures 308, 310, 314 or 316 extracted from a digital map may be processed as “candidate features” for identifying and characterizing an egress segment in a component area at least partially bounded by structures 308, 310, 314 or 316.

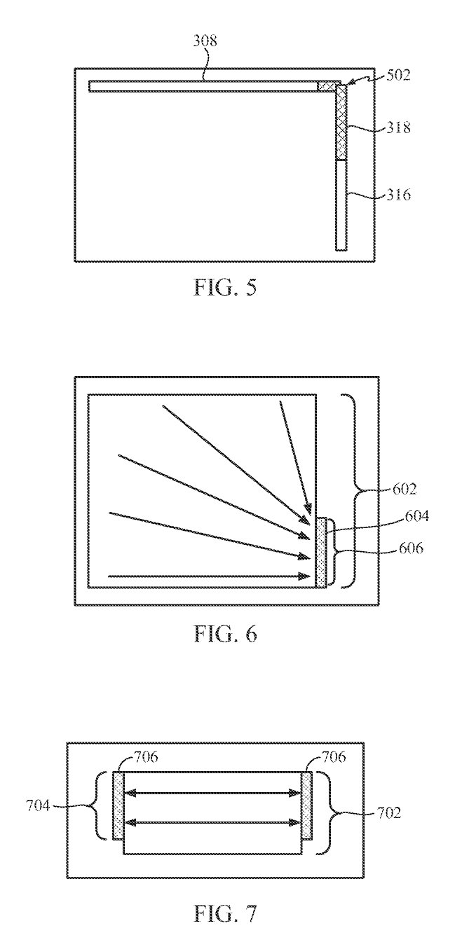

As shown in FIG. 3, structures 308 and 316 do not meet or touch, leaving a discontinuity or break 304 between structures 308 and 316. It may be observed that end 302 of structure 316 and end 318 of structure 308 are not connected to any other barrier structure. Here, discontinuity or break 304 may indicate an egress segment for component area 312. As can be observed, structure 316 comprises a straight, linear shape. In a particular example implementation as shown in FIG. 4, structure 316 may extended or projected along its linear shape to approximately intersect with structure 308. Here, a circle 306 of a sufficiently small radius centered at an end of the extended or projected portion of structure 316 may, at some point, intersect with structure 308 as shown. In a particular embodiment, this intersection of circle 306 with structure 308 may indicate detection of an egress segment 318. Furthermore, an extent to which structure 316 is extended or projected as a candidate feature until intersection with structure 308 may provide a width or size of the detected egress segment 318. Turning to FIG. 5, an egress portion may be further characterized by a segment 502 extending or projecting linearly from structure 308 to intersect with egress segment 318.

As pointed out above, a length or size of a discontinuity or break in a structure may be measured. In particular implementations, a discontinuity or break in a structure that is measured to be less than a threshold may not be classified as an egress segment. For example, particular building codes or practice may dictate or specify that a doorway is to be a minimum width (e.g., two feet). If a detected discontinuity or break in a wall is measured to be less than such a minimum width, the detected break or discontinuity may not be determined to be an egress segment.

For simplicity of explanation, the examples discussed above in connection with FIGS. 3, 4 and 5 are directed to detecting and/or measuring a single egress segment in a perimeter bounding a smaller area depicted in a map of a larger area. In other implementations, multiple egress segments in a perimeter bounding an area may be detected and/or measured using an approach to exhaustively evaluate breaks or discontinuities in depictions of structures forming the perimeter bounding the area as illustrated in FIGS. 3, 4 and 5.

FIGS. 6 and 7 illustrate particular examples of classifying a smaller area of a larger indoor area shown on a digital map according to an embodiment. Egress segment 604 in FIG. 6 and egress segments 706 may be identified and measured using techniques discussed above. In FIG. 6, an area bounded by a perimeter (e.g., formed by walls) includes an egress segment 604 as part of a discontinuity in the perimeter. As illustrated by directional arrows, movement from positions within the bounded area is likely to be toward egress segment 604. Also, a length 602 of a structure in which egress segment 604 is formed may be relatively large in comparison to a width 606 of egress segment 604. This feature may be suggest or indicate that the bounded area is a room (e.g., not a hallway).

FIG. 7 shows an area at least partially bounded by a perimeter (e.g., walls) including two egress segments 706 formed in discontinuities. As illustrated by directional arrows, movement from positions within the bounded area is likely to be toward egress segments 706. Also, a length 702 of a structure in which an egress segment 706 is formed may be relatively small in comparison to a width 704 of egress segment 706. This feature may suggest or indicate that the bounded area is a hallway that connects adjacent rooms.

In a particular implementation, a length of an egress segment in a perimeter bounding an area may be compared with a width of the bounded area. The bounded area may then be classified based, at least in part, on a proportionality of the length of the detected egress segment with respect to the width, and total number of egress points detected in a perimeter at least partially bounded the area.

In an implementation, e_{w} may be defined as a length of an egress segment in a perimeter at least partially bounding an area, c_{w} may be defined as a width of a component bounded area and nₑ may be defined as a total number of egress segments for the component bounded area. In a particular implementation, a number of egress points may be defined by a number of points or nodes in a portion of a routeability graph in the component bounded area on a path through the egress segment.

Feature c_{w} and e_{w} values may be measured from features extracted or determined from an at least partially bounded area identifiable from a digital map in a particular format using one or more of the feature recognition techniques discussed above. In an example, implementation, different parameters may be applied to feature values c_{w} and e_{w} for classifying the at least partially bounded area as a type of room, suggesting a likely movement of a user applicable to a probability heatmap. Letting a be a hallway threshold and letting 13 be a room threshold, rules may be established for classifying the bounded component area as follows:

If c_{w}/(e_{w}*nₑ)<α then classification is hallway;

If c_{w}/(e_{w}*nₑ)>β then classification is room;

If c_{w}/(e_{w}*nₑ)>α and <β then classification is unresolved.

In the above example, an at least partially bounded component area may be classified as either a hallway or a room. It should be understood, however, that these are merely two example classifications that may be determined for an at least partially bounded component area may be classified, and claimed subject matter is not limited in this respect. Furthermore, the particular examples provided above are merely examples of how a features of an at least partially bounded area extracted from a digital map may be evaluated for determining a classification of the at least partially bounded area.

For simplicity, comparisons of expression c_{w}/(e_{w}*nₑ) to α or β presume that sizes of egress segments are uniform as represented by e_{w}. In other implementations, a value for e_{w} may vary for different egress segments i of a bounded area as e_{wi}. Here, rules may be modified for classifying the bounded component area with N egress segments as follows:

If c_{w}[Σᵢ₌₀^{N}e_{wi}]⁻¹<α then classification is hallway;

If c_{w}[Σᵢ₌₀^{N}e_{wi}]⁻¹>β then classification is room;

If c_{w}[Σᵢ₌₀^{N}e_{wi}]⁻¹>α and <β then classification is unresolved.

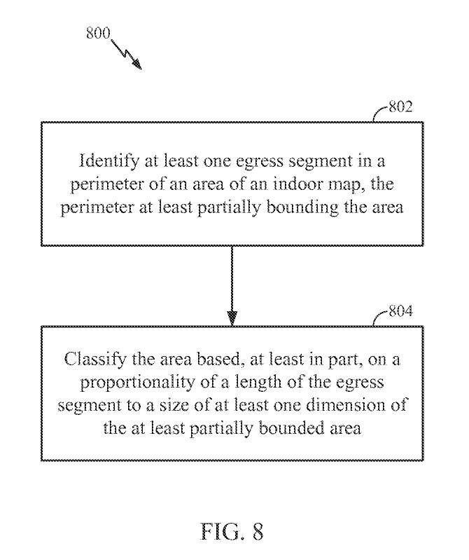

FIG. 8 illustrates an example process 800 for classifying a bounded component area of a larger indoor area represented in a digitally encoded map or electronic map according to a particular implementation. Here, a dimensionality of the bounded component area may be characterized based, at least in part, on features extracted from the digitally encoded map. For example, block 802 is directed to identifying at least one egress segment in a perimeter of an area of an indoor area, the perimeter at least partially bounding the component area. The component area may then be classified based, at least in part, on the characterized dimensionality. In block 804, for example, the bounded area may be classified based, at least in part, on a proportionality of a size (e.g., width) of the identified egress segment (e.g., e_{w}) to a size of at least one dimension of the at least partially bounded area (e.g., c_{w}) Here, the size of the at least one dimension of the at least partially bounded area may comprise a length of a structure in which the egress segment is formed (e.g., in a detected break or discontinuity) as illustrated by example above in FIGS. 6 and 7. It should be understood, however, that these are merely examples of how an area may be classified based, at least in part, on a proportionality of a size of an egress segment to a size of a dimension of an at least partially bounded area, and claimed subject matter is not limited in this respect.

In a particular implementation, as pointed out above, a mobile device may receive or maintain an electronic or digitally encoded map of an indoor area for display on a display device (e.g., LCD device) to assist the user in navigating. Among other things, a navigation application hosted on the mobile device may indicate an estimated current location of the mobile device laid over a displayed image of the indoor area generated from the electronic map. In a particular scenario, if a mobile device is located near a boundary between a first bounded area and a second bounded area (e.g., near a wall or doorway separating a corridor or hallway and a room), uncertainty in a precise location of the mobile device may suggest an ambiguity as to whether the mobile device is located within either the first bounded area or the second bounded area. In a particular implementation, as discussed below, such an ambiguity may be resolved based, at least in part, on classifications of the bounded areas (e.g., as a room or corridor/hallway) and an inferred a physical activity of a user co-located with the mobile device.

In particular implementations, a mobile device may comprise one or more inertial sensors (e.g., accelerometers, magnetometer, gyroscope compass, etc.) capable of generating signals responsive to movement of the mobile device (e.g., while being co-located with a user as being worn, held, etc.). Here, the mobile device may comprise a processing device capable of inferring a particular physical activity of a user co-located with the mobile device based, at least in part, on signals generated by such sensors in response to movement. The inferred particular activity, along with classifications of candidate bounded areas including a location of the mobile device, may be used to resolved the aforementioned ambiguities of the location of the mobile device.

In one particular implementation, a bounded area may be classified (e.g., as either a room or corridor/hallway) based, at least in part on a likelihood of a person performing a particular physical activity if located within the bounded area. For example, there may be a higher likelihood of a person walking or running if the person is located in a hallway or corridor versus a room with a single egress segment. Conversely, there may be a higher likelihood of a person not running or walking (e.g., sitting, standing, lying down, etc.) if the person is located in a room with a single egress segment rather than a hallway or corridor.

In a particular implementation, a user co-located with a mobile device (e.g., wearing, holding or carrying the mobile device, etc.) may be more likely to be performing a particular physical activity if located in a function or purpose of a particular classification of bounded area. For example, a user that is inferred to be walking or running may have a higher likelihood of being located in a hallway or corridor rather than a bounded area for particular room with a single egress segment. Conversely, a user that is inferred to not be running or walking (e.g., sitting or standing) may have a higher likelihood of being located in a bounded area with a single egress segment (e.g., classified as a room rather than a corridor or hallway) rather than a corridor or hallway. In one implementation, a probability that a user is performing a particular physical activity of a person may be computed based, at least in part, on one or more signals received from inertial sensors on a mobile device co-located with the mobile device.

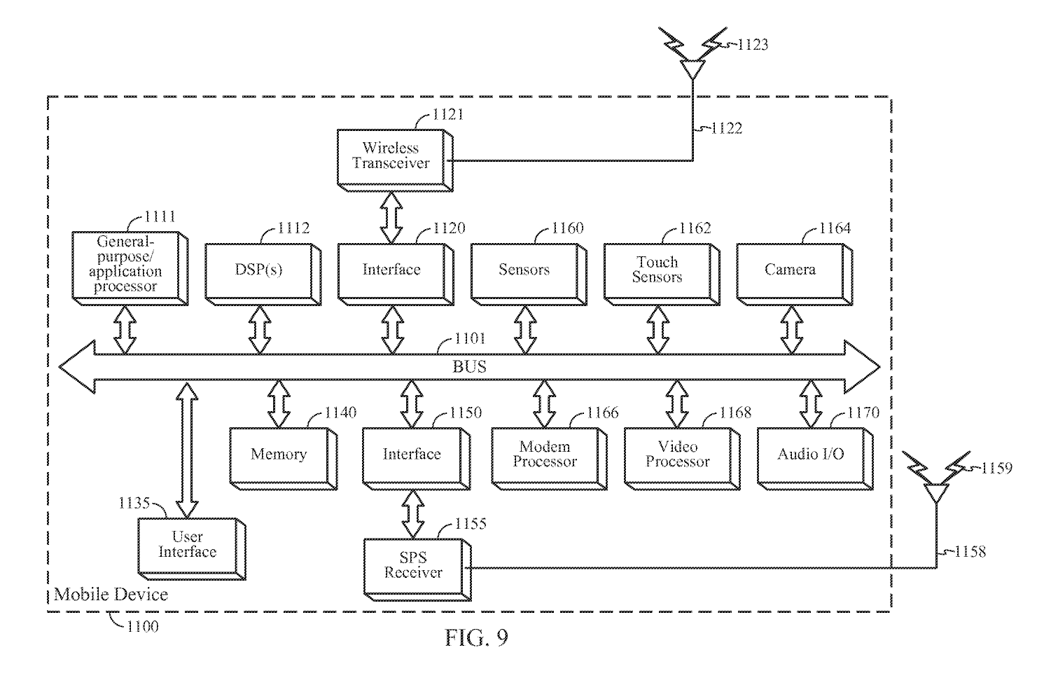

Referring to the particular example above, an uncertainty in a precise location of a mobile device may suggest an ambiguity as to whether the mobile device is located in particular candidate proximate bounded areas (e.g., a room or corridor/hallway believed to be in the general areal of the location). Computed likelihoods that a user co-located with the mobile device is performing particular physical activities may be applied to thresholds to infer a current physical activity. For example, a current physical activity of a user co-located with the mobile device may be inferred to be walking or running if a computed likelihood that the user is walking or running exceeds a threshold. The inferred physical activity may then be used to resolve the particular ambiguity for display of the location of the mobile device in a particular bounded area (e.g., display of the location within a corridor or hallway on a displayed map instead of a room if the inferred physical activity is running or walking). FIG. 9 is a schematic diagram of a mobile device according to an embodiment. Mobile device 100 (FIG. 1) may comprise one or more features of mobile device 1100 shown in FIG. 2. In certain embodiments, mobile device 1100 may also comprise a wireless transceiver 1121 which is capable of transmitting and receiving wireless signals 1123 via wireless antenna 1122 over a wireless communication network. Wireless transceiver 1121 may be connected to bus 1101 by a wireless transceiver bus interface 1120. Wireless transceiver bus interface 1120 may, in some embodiments be at least partially integrated with wireless transceiver 1121. Some embodiments may include multiple wireless transceivers 1121 and wireless antennas 1122 to enable transmitting and/or receiving signals according to a corresponding multiple wireless communication standards such as, for example, versions of IEEE Std. 802.11, CDMA, WCDMA, LTE, UMTS, GSM, AMPS, Zigbee and Bluetooth, just to name a few examples.

Mobile device 1100 may also comprise SPS receiver 1155 capable of receiving and acquiring SPS signals 1159 via SPS antenna 1158. SPS receiver 1155 may also process, in whole or in part, acquired SPS signals 1159 for estimating a location of mobile device 1000. In some embodiments, general-purpose processor(s) 1111, memory 1140, DSP(s) 1112 and/or specialized processors (not shown) may also be utilized to process acquired SPS signals, in whole or in part, and/or calculate an estimated location of mobile device 1100, in conjunction with SPS receiver 1155. Storage of SPS or other signals for use in performing positioning operations may be performed in memory 1140 or registers (not shown).

Also shown in FIG. 9, mobile device 1100 may comprise digital signal processor(s) (DSP(s)) 1112 connected to the bus 1101 by a bus interface 1110, general-purpose processor(s) 1111 connected to the bus 1101 by a bus interface 1110 and memory 1140. Bus interface 1110 may be integrated with the DSP(s) 1112, general-purpose processor(s) 1111 and memory 1140. In various embodiments, functions may be performed in response execution of one or more machine-readable instructions stored in memory 1140 such as on a computer-readable storage medium, such as RAM, ROM, FLASH, or disc drive, just to name a few example. The one or more instructions may be executable by general-purpose processor(s) 1111, specialized processors, or DSP(s) 1112. Memory 1140 may comprise a non-transitory processor-readable memory and/or a computer-readable memory that stores software code (programming code, instructions, etc.) that are executable by processor(s) 1111 and/or DSP(s) 1112 to perform functions described herein.

Also shown in FIG. 9, a user interface 1135 may comprise any one of several devices such as, for example, a speaker, microphone, display device, vibration device, keyboard, touch screen, just to name a few examples. In a particular implementation, user interface 1135 may enable a user to interact with one or more applications hosted on mobile device 1100. For example, devices of user interface 1135 may store analog or digital signals on memory 1140 to be further processed by DSP(s) 1112 or general purpose processor 1111 in response to action from a user. Similarly, applications hosted on mobile device 1100 may store analog or digital signals on memory 1140 to present an output signal to a user. In another implementation, mobile device 1100 may optionally include a dedicated audio input/output (I/O) device 1170 comprising, for example, a dedicated speaker, microphone, digital to analog circuitry, analog to digital circuitry, amplifiers and/or gain control. It should be understood, however, that this is merely an example of how an audio I/O may be implemented in a mobile device, and that claimed subject matter is not limited in this respect. In another implementation, mobile device 1100 may comprise touch sensors 1162 responsive to touching or pressure on a keyboard or touch screen device.

Mobile device 1100 may also comprise a dedicated camera device 1164 for capturing still or moving imagery. Camera device 1164 may comprise, for example an imaging sensor (e.g., charge coupled device or CMOS imager), lens, analog to digital circuitry, frame buffers, just to name a few examples. In one implementation, additional processing, conditioning, encoding or compression of signals representing captured images may be performed at general purpose/application processor 1111 or DSP(s) 1112. Alternatively, a dedicated video processor 1168 may perform conditioning, encoding, compression or manipulation of signals representing captured images. Additionally, video processor 1168 may decode/decompress stored image data for presentation on a display device (not shown) on mobile device 1100.

Mobile device 1100 may also comprise sensors 1160 coupled to bus 1101 which may include, for example, inertial sensors and environment sensors. Inertial sensors of sensors 1160 may comprise, for example accelerometers (e.g., collectively responding to acceleration of mobile device 1100 in three dimensions), one or more gyroscopes or one or more magnetometers (e.g., to support one or more compass applications). Environment sensors of mobile device 1100 may comprise, for example, temperature sensors, barometric pressure sensors, ambient light sensors, camera imagers, microphones, just to name few examples. Sensors 1160 may generate analog or digital signals that may be stored in memory 1140 and processed by DPS(s) or general purpose application processor 1111 in support of one or more applications such as, for example, applications directed to positioning or navigation operations.

In a particular implementation, a digital map of an indoor area may be stored in a particular format in memory 1140. The digital map may have been obtained from messages containing navigation assistance data from a remote server. General purpose/application processor 1111 may execute instructions to processes the stored digital map to identify and classify component areas bounded by a perimeter of structures indicated in the digital map. As pointed out above, these executed instructions may specify identifying and characterizing egress segments in structures forming a perimeter bounding a component area and classifying the bounded component area based, at least in part, on a proportionality of a size of at least one identified egress segment to a size of at least one dimension of the bounded component area. In one implementation, a mobile device may further apply crowed sourced data (e.g., obtained from a location server) to confirm an inferences of an egress segment. For example, if there is a history of mobile devices moving through a feature presumed to be an egress segment, the feature may be confirmed as providing an egress segment.

In a particular implementation, mobile device 1100 may comprise a dedicated modem processor 1166 capable of performing baseband processing of signals received and downconverted at wireless transceiver 1121 or SPS receiver 1155. Similarly, modem processor 1166 may perform baseband processing of signals to be upconverted for transmission by wireless transceiver 1121. In alternative implementations, instead of having a dedicated modem processor, baseband processing may be performed by a general purpose processor or DSP (e.g., general purpose/application processor 1111 or DSP(s) 1112). It should be understood, however, that these are merely examples of structures that may perform baseband processing, and that claimed subject matter is not limited in this respect.

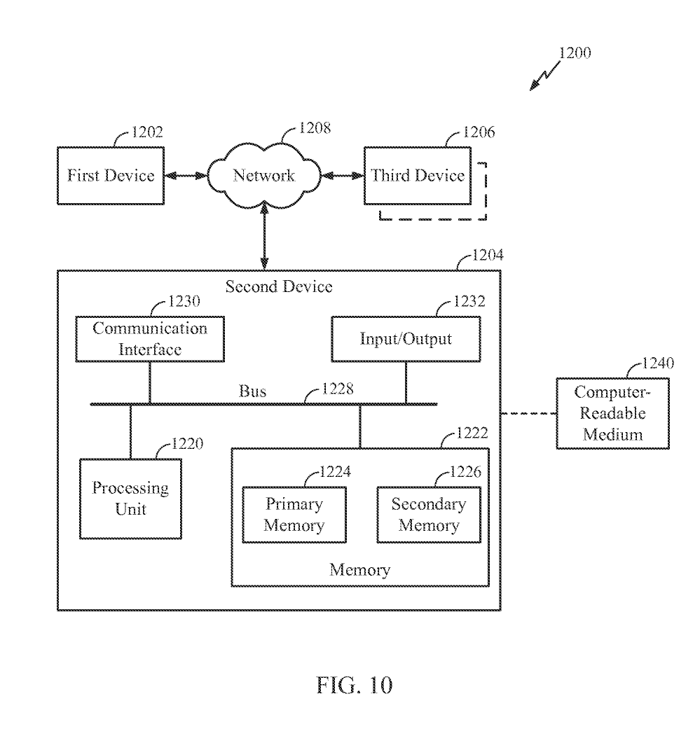

FIG. 10 is a schematic diagram illustrating an example system 1200 that may include one or more devices configurable to implement techniques or processes described above, for example, in connection with FIG. 1. System 1200 may include, for example, a first device 1202, a second device 1204, and a third device 1206, which may be operatively coupled together through a wireless communications network 1208. In an aspect, first device 1202 may comprise a server capable of providing positioning assistance data such as, for example, a base station almanac. First device 1202 may also comprise a server capable of providing an LCI to a requesting mobile device based, at least in part, on a rough estimate of a location of the requesting mobile device. First device 1202 may also comprise a server capable of providing indoor positioning assistance data relevant to a location of an LCI specified in a request from a mobile device. Second and third devices 1204 and 1206 may comprise mobile devices, in an aspect. Also, in an aspect, wireless communications network 1208 may comprise one or more wireless access points, for example. However, claimed subject matter is not limited in scope in these respects.

First device 1202, second device 1204 and third device 1206, as shown in FIG. 10, may be representative of any device, appliance or machine (e.g., such as local transceiver 115 or servers 140, 150 or 155 as shown in FIG. 1) that may be configurable to exchange data over wireless communications network 1208. By way of example but not limitation, any of first device 1202, second device 1204, or third device 1206 may include: one or more computing devices or platforms, such as, e.g., a desktop computer, a laptop computer, a workstation, a server device, or the like; one or more personal computing or communication devices or appliances, such as, e.g., a personal digital assistant, mobile communication device, or the like; a computing system or associated service provider capability, such as, e.g., a database or data storage service provider/system, a network service provider/system, an Internet or intranet service provider/system, a portal or search engine service provider/system, a wireless communication service provider/system; or any combination thereof. Any of the first, second, and third devices 1202, 1204, and 1206, respectively, may comprise one or more of a base station almanac server, a base station, or a mobile device in accordance with the examples described herein.

Similarly, wireless communications network 1208 (e.g., in a particular of implementation of network 130 shown in FIG. 1), may be representative of one or more communication links, processes, or resources configurable to support the exchange of data between at least two of first device 1202, second device 1204, and third device 1206. By way of example but not limitation, wireless communications network 1208 may include wireless or wired communication links, telephone or telecommunications systems, data buses or channels, optical fibers, terrestrial or space vehicle resources, local area networks, wide area networks, intranets, the Internet, routers or switches, and the like, or any combination thereof. As illustrated, for example, by the dashed lined box illustrated as being partially obscured of third device 1206, there may be additional like devices operatively coupled to wireless communications network 1208.

It is recognized that all or part of the various devices and networks shown in system 1200, and the processes and methods as further described herein, may be implemented using or otherwise including hardware, firmware, software, or any combination thereof.

Thus, by way of example but not limitation, second device 1204 may include at least one processing unit 1220 that is operatively coupled to a memory 1222 through a bus 1228.

Processing unit 1220 is representative of one or more circuits configurable to perform at least a portion of a data computing procedure or process. By way of example but not limitation, processing unit 1220 may include one or more processors, controllers, microprocessors, microcontrollers, application specific integrated circuits, digital signal processors, programmable logic devices, field programmable gate arrays, and the like, or any combination thereof.

Memory 1222 is representative of any data storage mechanism. Memory 1222 may include, for example, a primary memory 1224 or a secondary memory 1226. Primary memory 1224 may include, for example, a random access memory, read only memory, etc. While illustrated in this example as being separate from processing unit 1220, it should be understood that all or part of primary memory 1224 may be provided within or otherwise co-located/coupled with processing unit 1220.

In a particular implementation, a digital map of an indoor area may be stored in a particular format in memory 1222. Processing unit 1220 may execute instructions to processes the stored digital map to identify and classify component areas bounded by a perimeter of structures indicated in the digital map. As pointed out above, these executed instructions may specify identifying and characterizing egress segments in structures forming a perimeter bounding a component area and classifying the bounded component area based, at least in part, on a proportionality of a size of at least one identified egress segment to a size of at least one dimension of the bounded component area.

Secondary memory 1226 may include, for example, the same or similar type of memory as primary memory or one or more data storage devices or systems, such as, for example, a disk drive, an optical disc drive, a tape drive, a solid state memory drive, etc. In certain implementations, secondary memory 1226 may be operatively receptive of, or otherwise configurable to couple to, a computer-readable medium 1240. Computer-readable medium 1240 may include, for example, any non-transitory medium that can carry or make accessible data, code or instructions for one or more of the devices in system 1200. Computer-readable medium 1240 may also be referred to as a storage medium.

Second device 1204 may include, for example, a communication interface 1030 that provides for or otherwise supports the operative coupling of second device 1204 to at least wireless communications network 1208. By way of example but not limitation, communication interface 1230 may include a network interface device or card, a modem, a router, a switch, a transceiver, and the like.

Second device 1204 may include, for example, an input/output device 1232. Input/output device 1232 is representative of one or more devices or features that may be configurable to accept or otherwise introduce human or machine inputs, or one or more devices or features that may be configurable to deliver or otherwise provide for human or machine outputs. By way of example but not limitation, input/output device 1232 may include an operatively configured display, speaker, keyboard, mouse, trackball, touch screen, data port, etc.

The methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Wireless communication techniques described herein may be in connection with various wireless communications networks such as a wireless wide area network (“WWAN”), a wireless local area network (“WLAN”), a wireless personal area network (WPAN), and so on. The term “network” and “system” may be used interchangeably herein. A WWAN may be a Code Division Multiple Access (“CDMA”) network, a Time Division Multiple Access (“TDMA”) network, a Frequency Division Multiple Access (“FDMA”) network, an Orthogonal Frequency Division Multiple Access (“OFDMA”) network, a Single-Carrier Frequency Division Multiple Access (“SC-FDMA”) network, or any combination of the above networks, and so on. A CDMA network may implement one or more radio access technologies (“RATs”) such as cdma2000, Wideband-CDMA (“W-CDMA”), to name just a few radio technologies. Here, cdma2000 may include technologies implemented according to IS-95, IS-2000, and IS-856 standards. A TDMA network may implement Global System for Mobile Communications (“GSM”), Digital Advanced Mobile Phone System (“D-AMPS”), or some other RAT. GSM and W-CDMA are described in documents from a consortium named “3rd Generation Partnership Project” (“3GPP”). Cdma2000 is described in documents from a consortium named “3rd Generation Partnership Project 2” (“3GPP2”). 3GPP and 3GPP2 documents are publicly available. 4G Long Term Evolution (“LTE”) communications networks may also be implemented in accordance with claimed subject matter, in an aspect. A WLAN may comprise an IEEE 802.11x network, and a WPAN may comprise a Bluetooth network, an IEEE 802.15x, for example. Wireless communication implementations described herein may also be used in connection with any combination of WWAN, WLAN or WPAN.

In another aspect, as previously mentioned, a wireless transmitter or access point may comprise a femtocell, utilized to extend cellular telephone service into a business or home. In such an implementation, one or more mobile devices may communicate with a femtocell via a code division multiple access (“CDMA”) cellular communication protocol, for example, and the femtocell may provide the mobile device access to a larger cellular telecommunication network by way of another broadband network such as the Internet.

Techniques described herein may be used with an SPS that includes any one of several GNSS and/or combinations of GNSS. Furthermore, such techniques may be used with positioning systems that utilize terrestrial transmitters acting as “pseudolites”, or a combination of SVs and such terrestrial transmitters. Terrestrial transmitters may, for example, include ground-based transmitters that broadcast a PN code or other ranging code (e.g., similar to a GPS or CDMA cellular signal). Such a transmitter may be assigned a unique PN code so as to permit identification by a remote receiver. Terrestrial transmitters may be useful, for example, to augment an SPS in situations where SPS signals from an orbiting SV might be unavailable, such as in tunnels, mines, buildings, urban canyons or other enclosed areas. Another implementation of pseudolites is known as radio-beacons. The term “SV”, as used herein, is intended to include terrestrial transmitters acting as pseudolites, equivalents of pseudolites, and possibly others. The terms “SPS signals” and/or “SV signals”, as used herein, is intended to include SPS-like signals from terrestrial transmitters, including terrestrial transmitters acting as pseudolites or equivalents of pseudolites.

The terms, “and,” and “or” as used herein may include a variety of meanings that will depend at least in part upon the context in which it is used. Typically, “or” if used to associate a list, such as A, B or C, is intended to mean A, B, and C, here used in the inclusive sense, as well as A, B or C, here used in the exclusive sense. Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, the particular features, structures, or characteristics may be combined in one or more examples. Examples described herein may include machines, devices, engines, or apparatuses that operate using digital signals. Such signals may comprise electronic signals, optical signals, electromagnetic signals, or any form of energy that provides information between locations.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of the appended claims, and equivalents thereof.

What is claimed is:

1. A method of classifying portions of an area represented in a map comprising:
executing instructions by a computing device to:
characterize a dimensionality of an at least partially bounded component area of a larger area represented in a digitally encoded map stored in a memory based, at least in part, on features extracted from the digitally encoded map; and
generate one or more signals indicating a classification of the at least partially bounded component area based, at least in part, on the characterized dimensionality.

2. The method of claim 1, and further comprising executing said instructions by said computing device to characterize said dimensionality by:
identifying at least one egress segment in a perimeter of the at least partially bounded component area based, at least in part, on the features extracted from the digitally encoded map, the perimeter at least partially bounding the at least partially bounded component area; and
characterizing said dimensionality based, at least in part, on a proportionality of a length of the identified at least one egress segment to a size of at least one dimension of the at least partially bounded component area.

3. The method of claim 2, and further comprising executing said instructions by said computing device to identify said at least one egress segment by:
identifying a candidate feature in the digitally encoded map;
extending a dimension of the candidate feature by an amount until the candidate feature intersects with another feature; and
determining the length of the identified at least one egress segment based, at least in part, on the amount.

4. The method of claim 2, and further comprising executing said instructions by said computing device to generate one or more signals indicative of a likelihood of transition through said identified at least one egress segment based, at least in part, on said classification of said at least partially bounded component area.

5. The method of claim 1, wherein said classification of said at least partially bounded component area is a room.

6. The method of claim 1, wherein said classification of said at least partially bounded component area is a hallway.

7. The method of claim 1, and further comprising executing said instructions by said computing device to generate one or more signals representing at least a portion of a probability heatmap based, at least in part, on said classification of said at least partially bounded component area.

8. The method of claim 7, and further comprising transmitting said one or more signals representing said portion of said probability heatmap over a communication network to a mobile device for use as positioning assistance data.

9. The method of claim 7, and further comprising applying said probability heatmap to one or more measurements to estimate a motion state of a mobile device.

10. An apparatus for classifying portions of an area represented in a map comprising:
a memory device;
a processor to:
characterize a dimensionality of a bounded component area of a larger area represented in a digitally encoded map stored in the memory device based, at least in part, on features extracted from the digitally encoded map; and
generate one or more signals indicating a classification of the bounded component area based, at least in part, on the characterized dimensionality.

11. The apparatus of claim 10, and further comprising a transmitter, and wherein said processor is further to:
generate one or more signals representing at least a portion of a probability heatmap based, at least in part, on said classification of said bounded component area; and
initiate transmission of said portion of said probability heatmap to a mobile device as positioning assistance data through said transmitter.

12. The apparatus of claim 10, wherein said processor is further to:
generate one or more signals representing at least a portion of a probability heatmap based, at least in part, on said classification of said bounded component area; and
apply said one or more signals representing said portion of said probability heatmap to estimate a motion state of a mobile device.

13. An article comprising:
a non-transitory storage medium comprising machine-readable instructions stored thereon which are executable by a special purpose computing apparatus to:
extract features from a digitally encoded map stored in a memory device;
characterize a dimensionality of a bounded component area of a larger area represented in the digitally encoded map based, at least in part, on said features extracted from the digitally encoded map; and
generate one or more signals indicating a classification of the bounded component area based, at least in part, on the characterized dimensionality.

14. An apparatus for classifying portions of an area represented in a digitally encoded map comprising:
means for characterizing a dimensionality of a bounded component area of a larger area represented in the digitally encoded map stored in a memory based, at least in part, on features extracted from said digitally encoded map; and
means for classifying the bounded component area based, at least in part, on the characterized dimensionality.

15. A method of displaying a location of a mobile device comprising:
receiving one or more signals from one or more sensors responsive to movement of the mobile device;
inferring that a user co-located with the mobile device is performing a particular physical activity based, at least in part, on the received one or more signals;
determining a classification of at least one bounded area in an electronic map; and
displaying the location of the mobile device on the electronic map as being inside of or outside of the at least one bounded area based, at least in part, on the classification of the at least one bounded area and in response to inferring that said user co-located with the mobile device is performing the particular physical activity.

16. The method of claim 15, wherein the classification is based, at least in part, on a likelihood of a person walking or running in the at least one bounded area if the person is located in the at least one bounded area.

17. The method of claim 15, wherein inferring that said user co-located with the mobile device is performing the particular physical activity further comprises computing a likelihood that said user co-located with the mobile device is walking or running based, at least in part, on the received one or more signals.

18. The method of claim 17, wherein the at least one bounded area is classified as a hallway or corridor, and the computed likelihood exceeds a threshold value.

19. The method of claim 17, wherein the at least one bounded area is classified as a room, and the computed likelihood does not exceed a threshold value.

20. The method of claim 15, wherein the at least one bounded area is classified as a hallway or corridor, the method further comprising displaying the location as being within the at least one bounded area in response to inferring that said user co-located with the mobile device is walking or running based, at least in part, on the received one or more signals.

21. The method of claim 15, wherein the at least one bounded area is classified as a room, the method further comprising displaying the location as being outside of the at least one bounded area in response to inferring that said user co-located with the mobile device is walking or running.

22. The method of claim 15, wherein the at least one bounded area is classified as a hallway or corridor, the method further comprising displaying the location as being outside the at least one bounded area in response to inferring that said user co-located with the mobile device is not walking or running.

23. The method of claim 15, wherein the at least one bounded area is classified as a room, the method further comprising displaying the location as being inside the at least one bounded area in response to inferring that said user co-located with the mobile device is not walking or running.

24. An apparatus comprising:
one or more sensors to generate one or more signals responsive to movement of a mobile device;
a display device; and
one or more processors to:
infer that a user co-located with the mobile device is performing a particular physical activity based, at least in part, on the one or more signals generated by the one or more sensors;
determine a classification of at least one bounded area in an electronic map; and
initiate display of an image on the display device indicating a location of the mobile device on the electronic map as being inside of or outside of the at least one bounded area based, at least in part, on the classification of the at least one bounded area and in response to inferring that said user co-located with the mobile device is performing the particular physical activity.

25. An article comprising:
a non-transitory storage medium comprising machine-readable instructions stored thereon which are executable by a special purpose computing apparatus to:
a display device; and
one or more processors to:
infer that a user co-located with a mobile device is performing a particular physical activity based, at least in part, on one or more signals generated by one or more sensors responsive to movement of the user co-located with the mobile device;
determine a classification of at least one bounded area in an electronic map; and
initiate display of an image on the display device indicating a location of the mobile device on the electronic map as being inside of or outside of the at least one bounded area based, at least in part, on the classification of the at least one bounded area and in response to inferring that said user co-located with the mobile device is performing the particular physical activity.

26. An apparatus comprising:
means for receiving one or more signals from one or more sensors responsive to movement of a mobile device;
means for inferring that a user co-located with the mobile device is performing a particular physical activity based, at least in part, on the received one or more signals;
means for determining a classification of at least one bounded area in an electronic map; and
means for displaying a location of the mobile device on the electronic map as being inside of or outside of the at least one bounded area based, at least in part, on the classification of the at least one bounded area and in response to inferring that said user co-located with the mobile device is performing the particular physical activity.
